(19) United States
(12) Patent Application Publication
(10) Pub. No.: US 2025/0324323 A1
(43) Pub. Date: Oct. 16, 2025

(54) REUSABLE AND SCALABLE METHOD OF DYNAMIC CONTROL FOR TRAFFIC OF LTE, 5G AND BEYOND

(71) Applicant: AT&T Intellectual Property I, L.P., Atlanta, GA (US)

(72) Inventors: Gueyoung Jung, Belle Mead, NJ (US); Matti Hiltunen, Morristown, NJ (US); Thomas Novlan, Jonestown, TX (US); Isfar Tariq, Austin, TX (US)

(73) Assignee: AT&T Intellectual Property I, L.P., Atlanta, GA (US)

(21) Appl. No.: 18/635,289

(22) Filed: Apr. 15, 2024

(51) Int. Cl. H04W 28/086; H04W 28/02; H04W 72/121

(52) U.S. Cl. CPC H04W 28/086; H04W 28/0268; H04W 72/121

(57) ABSTRACT

Aspects of the subject disclosure may include, for example, grouping user equipment (UEs) in a radio access network (RAN) according to performance data and UE time information, forming UE groups, grouping carriers of the RAN according to traffic patterns and carrier time information, forming carrier groups, combining selected UE groups and selected carrier groups based on common time information, forming combinations, building machine learning (ML) models for each combination of the combinations, providing current UE performance information and current carrier traffic information to the ML model, and receiving, from the ML model, a network modification recommendation to improve one or more key performance indicators (KPIs) of the RAN. Other embodiments are disclosed.

### FIELD OF THE DISCLOSURE

The subject disclosure relates to a method for dynamic control of traffic in mobile communication networks.

### BACKGROUND

Resource demands for new wireless network services continues to increase. Examples of increasing demand include augmented reality (AR) and virtual reality (VR) applications, short videos, personal artificial intelligence (AI) assistants, smart vehicles, etc. Further, as fifth generation (5G) mobile networking becomes popular and subsequent generations are developed, the complexity of controlling and managing user equipment (UEs) and radio access network (RAN) resources increases. It is known for methods based on artificial intelligence and machine learning (AI/ML) to try to resolve the issues. However, such solutions have required substantial cost and time to build and to manage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating a prior art mobile communication network.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a system 230 functioning within the communications network 125 of FIG. 1 in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for grouping user equipment (UE) devices in a radio network according to performance characteristics and traffic patterns, grouping carriers in the radio network according to performance characteristics and traffic patterns, combining the groups of UEs and carriers according to common time information and forming artificial intelligence/machine learning (AI/ML) models for the different combinations of UE groups and carrier groups. The AI/ML models may be used to control and improve performance in the radio network. Further, the AI/ML models may be extended to other portions of the radio network based on similarities of the performance characteristics and traffic patterns there to the groups of UEs and groups of carriers. Other embodiments are described in the subject disclosure.

One or more aspects of the subject disclosure include collecting user equipment (UE) performance data for UEs of a radio access network (RAN), identifying common UE characteristics among the UE performance data, forming UE groups based on the common UE characteristics, wherein UEs of a UE group share one or more common performance characteristics, collecting carrier performance data for a carrier of the RAN, identifying common carrier characteristics among the carrier performance data, and forming carrier groups based on the common carrier characteristics, wherein members of a carrier group share one or more common carrier performance characteristics. Aspects further include combining a selected UE group and a selected carrier group based on a shared common time period associated with the common UE characteristics of the selected UE group and the common carrier characteristics of the selected carrier group, forming a combination of the selected UE group and the selected carrier group and a time period, training the combination for a target goal, forming a trained combination, building a machine learning model based on the trained combination, providing current usage data to the machine learning model, receiving a network modification recommendation from the machine learning model, the network modification recommendation to improve a key performance indicator (KPI) of the RAN, and modifying the RAN according to the network modification recommendation.

One or more aspects of the subject disclosure include classifying a user equipment (UE) in a radio access network (RAN) into a UE group according to performance data and UE time information, classifying each connected carrier of carriers of the RAN into a carrier group according to traffic patterns and carrier time information, combining a selected UE group and selected carrier groups based on common time information, forming a combination, applying a machine learning (ML) model of the combination, providing current UE performance information and current carrier traffic information to the ML model, and receiving, from the ML model, a network modification recommendation to improve one or more key performance indicators (KPIs) of the RAN.

One or more aspects of the subject disclosure include grouping, by a processing system including a processor, user equipment (UEs) of a radio access network (RAN) based on performance characteristics and traffic patterns of the UEs in the RAN, forming UE groups, grouping, by the processing system, carriers of the RAN based on performance characteristics and traffic patterns of target areas of the RAN, forming carrier groups, grouping, by the processing system; respective UE groups of the UE groups and respective carrier groups of the carrier groups according to respective time information common to a respective UE group and a respective carrier group, forming respective combinations, and building respective machine learning models based on the respective combinations, each respective machine learning model operative to control a portion of the RAN based on input information about current activity in the RAN.

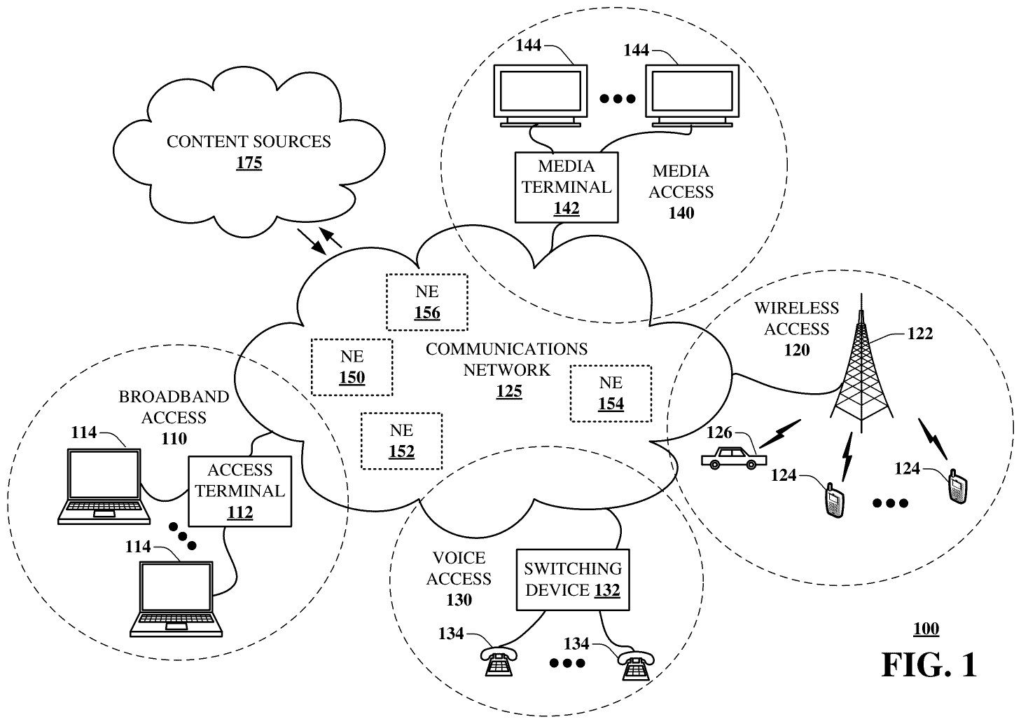

Referring now to FIG. 1, a block diagram is shown illustrating an example, non-limiting embodiment of a system 100 in accordance with various aspects described herein. For example, system 100 can facilitate in whole or in part grouping user equipment (UE) devices in a radio network according to performance characteristics and traffic patterns, grouping carriers in the radio network according to performance characteristics and traffic patterns, and combining the groups of UEs and groups of carriers according to common time information and thus forming artificial intelligence/machine learning (AI/ML) models based on the combinations. The AI/ML models may be used to control and improve performance in the radio network. Further, the AI/ML models may be extended to other portions of the radio network based on similarities of the performance characteristics and traffic patterns there to the groups of UEs and groups of carriers. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

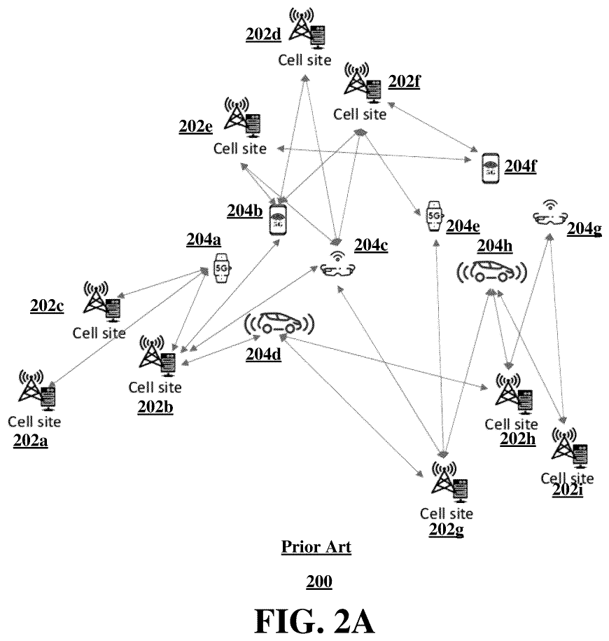

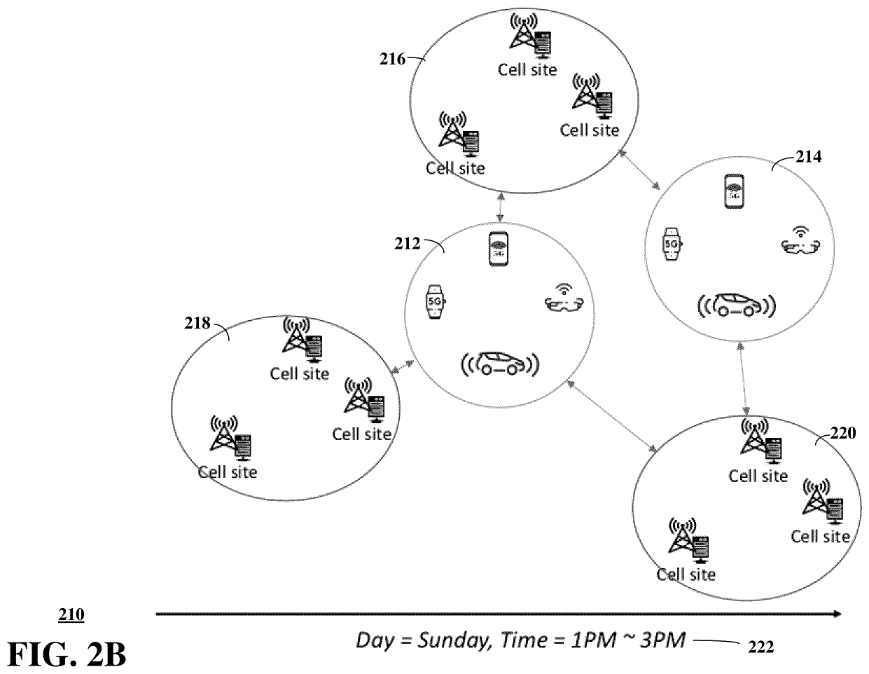

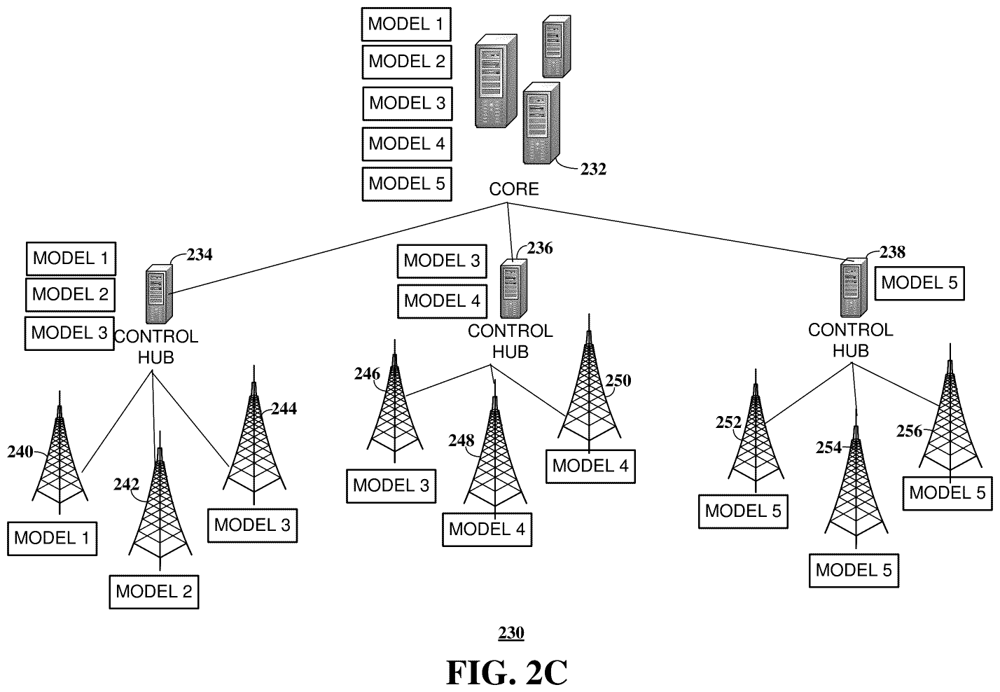

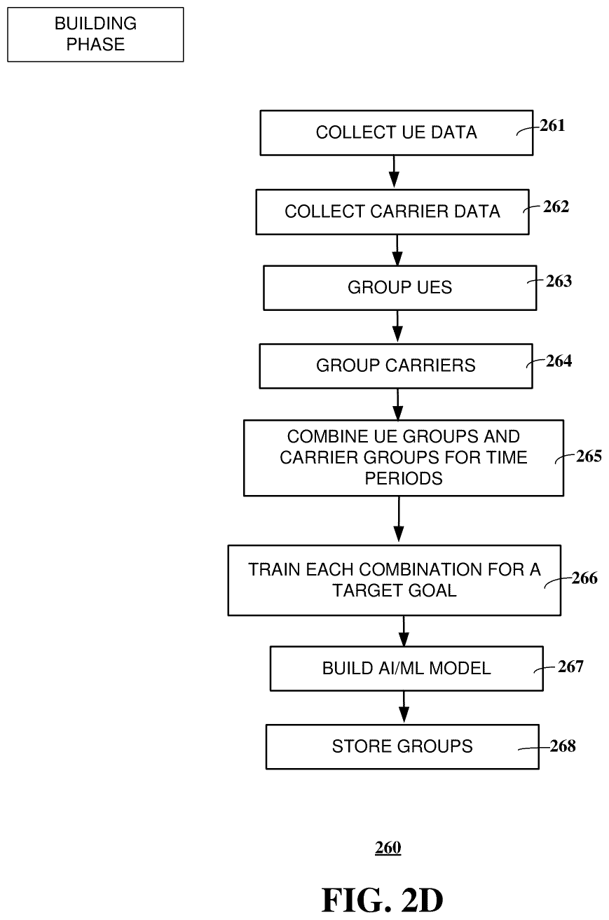

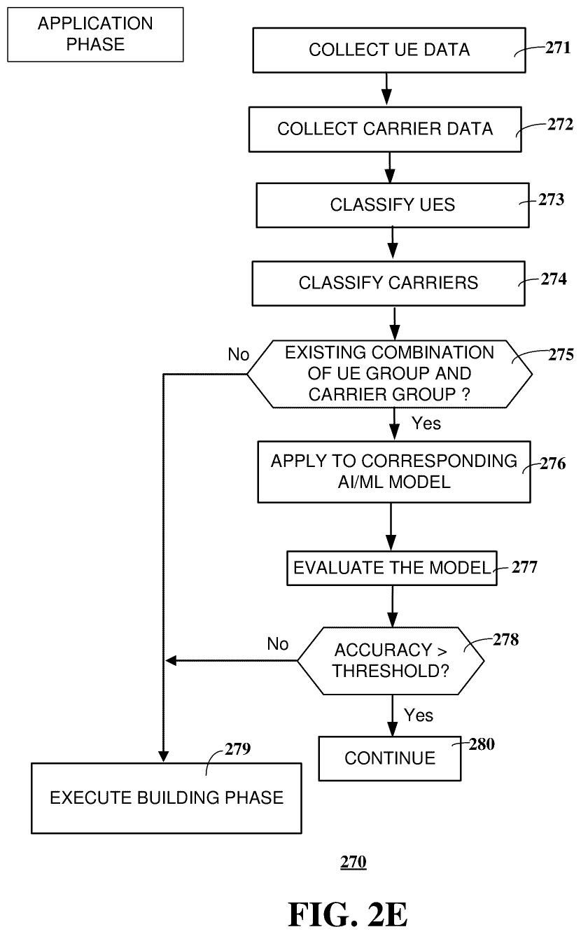

FIG. 2A is a block diagram illustrating a prior art mobile communication network 200. The mobile communication network 200 includes a number of cell sites including cell site 202a, cell site 202b, cell site 202c, cell site 202d, cell site 202e, cell site 202f, cell site 202g, cell site 202h, and cell site 202i (collectively “cell sites 202”). The cell sites 202 provide radio communications to user equipment devices (UE) in service areas associated with each of the cell sites, including UE 204a, UE 204b, UE 204c, UE 204d, UE 204e, UE 204f, UE 204g, and UE 204h (collectively, “UEs 204”). The UEs may include any user device equipped for mobile communications with cell sites, including wearable devices such as watches like UE 204a and UE 204e, goggles such as UE 204c and UE 204g, smartphones such as UE 204b and UE 204f, and vehicles such as UE 204d and UE 204h. FIG. 2A is intended to be exemplary only. Other networks will have other numbers of devices and cell sites, as well as other types of devices. In embodiments, a network such as the mobile communication network 200 may be referred to as a radio access network (RAN).

Over time, the mobile communication network 200 grows incrementally. The number of network devices such as cell sites 202 increases to provide additional capacity and to provide additional reach to new geographic areas. The number of UEs 204 increases in both number and type.

Conventionally, network operators of networks such as the mobile communication network 200 have sought to use machine learning (ML) models to control traffic and improve performance of the network. For example, data about network activity is collected over a time period. The data may be used to develop an ML model for network analysis and improvement. For example, a goal can be defined such as improving data throughput in an area of the network. In data transmission, network throughput is the amount of data moved successfully from a source to a destination in a given time period. Such ML models have been successful at improving network performance using network data.

However, currently there are too many cell sites 202 and too many UEs 204 for practical, feasible control of each individual UE device for better performance. Moreover, the combination of connections between a UE and adjacent cell sites is increasing rapidly. In particular, the conventional solutions are not scalable as the network size and number of network elements increases. For example, the artificial intelligence and machine learning (AI/ML) models need to collect a large amount of individual UE data for reliably modelling the network.

Further, conventional AI/ML models of the network are related to the network in a particular geographic area such as New York and New Jersey, Texas or the San Francisco Bay Area. However, the conventional AI/ML models are tied directly to the modelled location and are not portable from one area to another. Thus, for a new target area, the model must be developed from scratch by collecting enormous amounts of data to develop a new model for the new area.

In accordance with various aspects described herein, a method and a system enable control of a network such as the mobile communication network 200 based on artificial intelligence and machine learning to be scalable and reusable for current and future networks. This may be accomplished by abstracting the control environment (i.e., UEs, carriers, and their performance characteristics and traffic patterns) and computing similarity between environments. Thus, this method and system can lead to reducing cost and time to build and manage machine learning-based controllers and control RAN resources. The method and system further can lead to improved RAN performance in scalable and effective way.

FIG. 2B is a block diagram illustrating an example, non-limiting embodiment of a system 210 functioning in conjunction with the communications network 125 of FIG. 1 in accordance with various aspects described herein. The system 210 may implement a method to abstract a target environment including UEs, carriers or network operators, and their performance characteristics and traffic patterns, and build an artificial intelligence or machine learning (AI-ML) model for each distinguished combination between UEs and carriers for a certain time period. The system 210 and method group together performance characteristics and traffic patterns of UEs. This is not simply grouping by the application type of the UEs.

The method also groups performance characteristics and traffic patterns of target areas to sub-areas. In some embodiments, the method groups according to carrier, or the mobile network operator responsible for the network. Data or information about operation of a carrier's network may be collected and analyzed. Such data and information may be on a per-cell or per-sector basis, where a gNodeB or base station provides radio communication service to a cell or a sector of a cell (such as three sectors service 120 degrees azimuth around the gNodeB or antenna). The area served by a base station may be grouped, or the base station may be grouped with others to form a group.

Finally, the method groups according to time of traffic. Unique combination between UE groups, area groups, and time groups can represent a specific pattern and reduce complexity for modeling and control. Moreover, a corresponding AI/ML model can be applied to other new areas, UEs, and time period, once their performance and traffic patterns are similar.

In the system 210 of FIG. 2B, different types of grouping are applied in the radio communication network. In a first group 212 and a second group 214, performance characteristics and traffic patterns of the UEs are grouped together. Performance characteristics relate to information about technical features of the usage of the UEs such as amounts of data communicated over the radio communication network or required data rates for a UE. Different applications may have similar performance characteristics. Thus, an augmented reality game played using a UE in the form of goggles may communicate substantial data and require a very high data rate with very low latency for user enjoyment of the game. Similarly, a vehicle to vehicle (V2X) connection from one vehicle to another may also communicate substantial data and require low latency, for example to enable navigation and traffic coordination between vehicles. Thus, the first group 212 may include a virtual reality or augmented reality game played by teenagers in fast moving vehicles. The separate second group 214 may include the same game played at home in a stationary environment. Similarly, a video telecommunications meeting conducted in a moving vehicle may be grouped separately from a similar video telecommunications meeting conducted in an office environment. Groups may be defined by any suitable performance characteristics such as key performance indicators (KPIs) used by the network operator. Such KPIs include latency, throughput, and others. Further, grouping definitions may be changed dynamically to gain further insight or may evolve over time as such insight is gained.

Thus, the group 212 and the group 214 are formed based on performance characteristics and traffic patterns, not on UE type or a particular application being used on a UE. The group 212 and the group 214 each include UEs of different types such as smartphones, goggles, vehicles, etc. The different types of UEs may be using different applications such as gaming or videoconferencing. However, the performance characteristics and traffic patterns have a common aspect or a common element that maybe used to aggregate these devices and their performance characteristics and traffic patterns into a common group.

In a different type of grouping, performance characteristics and traffic patterns of UEs to sub-areas are grouped together. This type of grouping relates to geographic locations. Thus, group 216 may include communication data from urban areas, group 218 may include communication from suburban areas, and group 220 may include communication data from rural areas. For example, Manhattan in New York and portions of San Francisco may both be considered urban areas and may exhibit common traits of performance characteristics and traffic patterns. Different types of regions may exhibit or experience different communication traffic patterns, such as a university campus compared with a residential neighborhood or a highway, with vehicle traffic generating communication network traffic, compared with a shopping center in which shoppers generate communication network traffic. Definitions of urban, suburban or rural may be set according to any suitable standard such as population density of a particular or amount of communication in an area as measured by total data transferred or a rate of data transfer, etc. As noted, grouping definitions may be changed dynamically to gain further insight or may evolve over time as such insight is gained.

A third type of grouping is based on time of traffic. FIG. 2B shows a group 222 defined by traffic activity on a Sunday between 1 and 3 PM. Any other grouping may be used, for example to define different time windows such as weekly, daily, hourly, etc. Again, as noted, grouping definitions may be changed dynamically to gain further insight or may evolve over time as such insight is gained.

The data used to form the groups, including group 212, group 214, group 216, group 218, group 220 and group 222, may originate with any suitable source. For example, call detail record (CDR) data may be collected about each session by each UE in the network. CDR data and other collected data may include information about the UE involved in the data session, any other UE involved, one or more base stations involved in the data session, amount of data communicated, the change rate of data communicated, applications used in the data session, time and duration of the session, and others. Further, network data such as handovers from one base station to another and cell loading may be collected as well. Such data, and similar data, may be processed to perform the grouping of FIG. 2B.

In the example, one level of abstraction is used to form the groups. Unique combinations among UE groups such as group 212 and group 214, and area groups such as group 216, group 218 and group 220, and time groups including group 222, can represent a specific pattern. The pattern and the data associated with the pattern can be used to build an artificial intelligence/machine learning (AI/ML) model. The AI/ML model can then be applied to other new areas, UEs and time periods having similar performance and traffic patterns.

For example, the group 212 includes UEs using large amounts of low-latency data. Group 212 may be connected to group 216 as an area, which includes urban areas. Further, group 212 and group 216 may be associated with a group (not shown) that targets weekends including Saturdays and Sundays. An AI/ML model can be built for this first combination. In another example, the same group 212 of UEs associated with the same cities in group 216, but associated with weekdays, Mondays through Fridays, will have different data from the other example. An AI/ML model for the second combination will be different from the AI/ML model for the first combination.

In an exemplary embodiment, device data for each UE and network data for network communications may be used to form a vector for each UE. Similarities may be determined based on the UE vectors. In some embodiments, a clustering algorithm may be used to form each group such as group 212 and group 214. The clustering algorithm may be implemented in an AI/ML model to form the groups having common characteristics. Any suitable clustering algorithm or combination of algorithms may be used.

Similarly, suitable metrics for cell sites can be collected and vectorized and used for grouping the cell sites into groups such as group 216, group 218 and group 220. In the case of grouping by target areas, no specification of urban, suburban, rural or otherwise may need to be specified. Rather, the individual data for each cell site may be collected and subject to a clustering algorithm to group the cell sites by common features. The resulting group may include a mix of urban, suburban and rural sites that are clustered on the basis of other features.

Grouping by time can be handled similarly. Data associated with UE communication traffic and cell site traffic may be provided to one or more clustering algorithms. Common features may be identified by an AI/ML model to permit grouping of network activity according to times of the day or time durations. For example, network activity for the same region, such as New York city, may be collected and may vary over time. The data may be formed into multiple vectors. The clustering algorithm will identify common features among the data.

The system and method in accordance with FIG. 2B provide a variety of benefits. For given goal, such as maximizing UE throughput, in a target area, such as a football stadium, for specified time periods such as Sunday evening, the dynamic traffic control approach illustrated herein can build scalable AI/ML models to meet the goal by grouping UEs, areas, and time periods. This method also provides a way of reusing such AI/ML models in other new areas and UEs by classifying new UEs and carriers (or network operators) for certain time periods to existing UE groups, areas, and time periods. Such classifying may be based on the similarity of performance characteristics and traffic patterns. The illustrated method can be applied to any dynamic control interval and time period such as seconds, hourly, daily, weekly, monthly, even yearly.

A further immediate benefit is to allow RAN engineers and operators to set up a good initial carrier configuration setting in a new area once similarity is observed from existing traffic patterns of other areas, where AI/ML models were trained and built. For example, if a new network or subnetwork is to be built out in an area, the AI/ML models for a different but similar area may be used to set up an initial configuration for the new network or subnetwork. The AI/ML model that has been trained on the existing network data can be reused or adapted for the new network or subnetwork. Even if aspects of the existing network have significant differences from the new network, the existing AI/ML model can be used as a basis for modeling the new network and adjusted subsequently. The subsequent adjustment is much easier and cheaper to accomplish than building a new model from scratch. Overall, this method can save cost and time that would otherwise be spent to collect enormous data and train ML models.

In an example of the system 210 and method, a network operator may collect data about unique traffic patterns among groups of UEs during New York Yankee baseball games at Yankee stadium and surrounding parking lots. The network operator can build an AI/ML model to improve network performance at that location. For example, the AI/ML model may process network data and make recommendations to modify the network to improve data throughput at Yankee Stadium during Sunday home games. By identifying appropriate groups, the AI/ML model may be reused at Wrigley Field in Chicago to apply to network data for the network at the ballpark and surrounding parking areas. The AI/ML model can be reused at the new location with different groups of UEs to improve network performance, such as improving data throughput during Sunday night games.

FIG. 2C is a block diagram illustrating an example, non-limiting embodiment of a system 230 functioning within the communications network 125 of FIG. 1 in accordance with various aspects described herein. The system 230 illustrates a high-level view of a radio access network (RAN) architecture. The system 230 includes a core network 232, a group of control hubs including control hub 234, control hub 236, and control hub 238, and a group of cell sites. In the example, cell site 240, cell site 242, and cell site 244 are associated with the control hub 234; cell site 246, cell site 248, and cell site 250 are associated with the control hub 236; and cell site 252, cell site 254, and cell site 256 are associated with the control hub 238. Each respective cell site provides radio communication service to UEs in a respective service area. The components of the system 230 are interconnected for data communication in any suitable manner such as fiber optic cables or wireless connections. The organization and architecture of the system 230 is intended to be exemplary only.

Each cell site includes a controller for controlling operation of the components of the cell site and for managing communication with other components including a control hub and UEs. Further, as indicated, each cell site communicates with and is controlled by an associated control hub. The control hubs, in turn, communicate with and are controlled by the core network 232.

The core network 232 may be located in a cloud data center. In some embodiments, the core network 232 may be one core of multiple core networks. The core network 232 controls a group of control hubs. The core network 232 may be centrally located and manage many different AI/ML models. As indicated in FIG. 2C, the core network 232 manages model 1 through model 5 in this example. Managing the models may include collecting data necessary to develop the models, developing the models for use to achieve a particular respective purpose, distributing the models to other network locations, and modifying and updating the models as necessary.

Each hub controller is generally located in an area such as a large city or town. Each hub controller operates to control a group of cell sites. The hub controllers provide network coverage and manage a subset of the AI/ML models. In the illustrated example, the control hub 234 manages model 1, model 2 and model 3; the control hub 236 manages model 3 and model 4; control hub 238 manages model 4 only.

The respective cell sites are distributed over the service area. Each cell site provides coverage to a relatively small area and make use of a single AI/ML model. For example, in FIG. 2C, cell site 240 uses model 1; cell site 246 uses model 3; and cell site 256 uses model 5. The model identifiers such as model 1, model 2, etc., indicate that the model at a cell site is the same as the model with the same model identifier at another cell site. For example, cell site 244 and cell site 246 each use model 3. This indicates that they see a similar traffic pattern.

Each AI/ML model represents a unique combination of UE group, area group and time period group. Each AI/ML model can be applied to any cell site under control of the core network 232 or a respective control hub. If a particular cell site requires a particular model, the core network 232 operates to download or share the particular model to an appropriate control hub. The control hub will then distribute the particular model to the cell site.

In an embodiment, a respective cell site has awareness of the current conditions including what UE groups are present, information about performance characteristics and traffic patterns, as well as information about what type of area the cell site is located in. The respective cell site communicates this information to the control hub associated with the cell site. The cell site may request a model in return, a model which is tailored for the UE group and area group and time group of the cell site.

The control hub then operates to match an existing model that fits the characteristics of the cell site. If a matching model is found, the model is deployed to the cell site by the control hub. If no model is found, the control hub will query the core network 232 to determine if a model exists that conforms to the situation of the cell site, including the UE group, the area group and the time group. If the core network 232 has a suitable model, the model will be deployed to the control hub and then deployed to the cell site. Thus, models are deployed on demand from the cell site, based on observations of the cell site.

Preferably, the AI/ML models are independent of underlying data processing and communications equipment. In general, cell site equipment may be provided by different vendors, including both hardware and software. Similarly, the control hub equipment may be provided by different vendors, as well as the components of the core network 232. Thus, the AI/ML model should be interoperable among the different hardware and software of the different vendors. Further, the equipment may implement standard interfaces defined by Open Radio Access Network (ORAN) standards including the E2 interface used for near-real time control of the RAN from an xApp running on the near-real time RIC (RAN Intelligent controller) or O1 interface used for non-real time control of the RAN from an rApp running on a non-real time RIC.

FIG. 2D depicts an illustrative embodiment of a method 260 in accordance with various aspects described herein. The method 260 is one embodiment of a building phase for a system using AI/ML models to improve radio communication network operation. An embodiment of an application phase for the system is illustrated in FIG. 2E. The method 260 may be performed at any suitable location, such as a processing system of a core network of a network operator.

At step 261, method 260 includes collecting data of individual user equipment devices (UEs). Any suitable data may be collected. Examples include resource usage in the carrier to which the UE is connected, signal quality as reported by the UE or as measured by a network element, data throughput to the UE, and any other key performance indicators (KPIs) for the UE. Further, step 261 may include determining or obtaining rate-of-change information for any KPIs such as decreasing rate of KPIs and variance of KPIs over a time period. Still further, step 261 may include gathering information about carrier aggregation at the UE, in which more than a single carrier wave is used between a base station and the UE to increase throughput to the UE. Still further, step 261 may include collecting information about a current or past approximated geo-location and a user profile for a user of the UE. The information of step 261 may be collected from any suitable source such as call data records that record activity of the UE and network information that records information such as handovers, measured signal strength and other KPIs.

At step 262, the method 260 includes collecting data of carriers or mobile network operators. Any suitable data may be collected. Examples include features such as current traffic load and traffic load variation over time, information about an average signal strength, average throughput, handover statistics including a handover success rate related to handing over communication with a UE from one base station to another and any other suitable KPIs for the carrier. Further, step 262 may include determining or obtaining rate-of-change information for any carrier KPIs such as decreasing rate of KPIs and variance of KPIs over a time period. Still further, step 262 may include collecting information about a current or past approximated geo-location for the carrier and a carrier profile for the carrier. The information of step 262 may be collected from any suitable source such as call data records and network information that records information such as handovers, measured signal strength and other KPIs.

At step 263, two or more UEs are grouped based on features and time of activity. As described herein, UEs may be grouped according to performance characteristics and traffic patterns. The data used for grouping may include information about KPIs such as throughput, data volume, measured signal strength, and the change rate of such KPIs, whether the UE is in motion or stationary, etc. Separately, two or more UEs may be grouped according to performance characteristics and traffic patterns of areas or subareas. That is, UEs operating in similar areas are grouped together according to the similarities of the areas. The time period associated with UE activity is further used to group the UEs, such as a time of day, a calendar date, a time range during a date, etc. Grouping of UEs may be done by forming a vector describing UE features and time and performing a clustering algorithm on the vectors, such as k-means clustering.

At step 264, two or more carriers are grouped based on features of the carrier performance. Further, the carriers are grouped based on the time of carrier activity such as date, time of day, time duration and others. Grouping of carriers may similarly be achieved by forming vectors describing carrier features and time data, and performing a clustering algorithm on the vectors, such as k-means clustering.

At step 265, the UE groups from step 263 and the carrier groups from step 264 are combined for specific time periods from the data. For example, step 265 may include generating specific combinations between a UE group, a carrier group and a time period.

At step 266, the method 260 includes training each combination from step 265 for a target goal KPI. Examples of target goal KPIs include throughput, spectrum efficiency, power consumption, and interference. Step 266 may further include training each combination for control knobs such as load balancing and consolidation, adjusting antenna tilt, adjusting power thresholds, adjusting handover thresholds, etc. The control knobs are operational features that may be modified in a model to predict a response to the modification and determine a control to apply to the network to modify and improve network performance.

At step 267, an artificial intelligence or machine learning model is built using the groups and other information. Any suitable model may be used including, for example, a neural network model, an XGBoost model, and others. A model is built for each combination from step 265 and the model is validated.

At step 268, information is stored. The stored information includes information about the groups of step 263 and step 264, their traffic patterns and performance characteristics, and information about the AI/ML models for observed combinations of groups from step 267.

Thus, the method 260 may be used to collect current and historical data from a network and the UEs in the network and to build models. The models are suitable for developing modifications and improvements to the network to allow a network operator to enhance particular aspects of network operation, such as increasing throughput at a particular portion of the network, at a particular time. Moreover, the modeling and modifications made to one portion of the network may be borrowed or extended to other portions of the network by the network operator. These operations describe the application phase.

FIG. 2E depicts an illustrative embodiment of a method 270 in accordance with various aspects described herein. The method 270 is one embodiment of an application phase for a target area for a system using AI/ML models to improve radio communication network operation. The method 270 may be performed at any suitable location, such as a processing system of a core network of a network operator. The method 270 may be initiated by any suitable process such as a desire or need by network engineers to evaluate and improve a network portion or to build out a new network portion.

At step 271, current data for individual UE devices in the target area is collected by the network operator. The target area may be an existing network for which there is a need to develop an AI/ML model to control and optimize the network, or a newly developed network portion or subnetwork to which an existing model may be extended. Any suitable data may be collected. Examples include resource usage in the carrier to which the UE is connected, signal quality as reported by the UE or as measured by a network element, data throughput to the UE, any other key performance indicators (KPIs) for the UE, and the change rate of such KPIs. Further, step 271 may include gathering information about carrier aggregation at the UE and collecting information about a current or past approximated geo-location and a user profile for a user of the UE. The information of step 271 may be collected from any suitable source such as call data records.

At step 272, current data for carriers is collected by method 270. Any suitable data may be collected. Examples include features such as current traffic load and traffic load variation over time, information about average signal strengths, average throughput, handover statistics including a handover success rate related to handing over communication with a UE from one base station to another, any other suitable KPIs for the carrier, and the change rate of all such KPIs. Further, step 272 may include collecting information about a current or past approximated coverage area for the carrier and a carrier profile for the carrier. The information of step 272 may be collected from any suitable source such as call data records and network information that records information such as handovers, measured signal strength and other KPIs.

At step 273, UEs are classified to existing UE groups. For example, groups formed initially for UEs at step 263, FIG. 2D, may be used to classify the UEs to the groups. The classification may be done, for example using an AI/ML model to predict the correct label for input data in the form of a UE. The UE data may be vectorized.

At step 274, carriers are classified to existing carrier groups. For example, groups formed initially for carriers at step 264, FIG. 2D, may be used to classify the carriers to the groups. The classification may be done, for example using an AI/ML model to predict the correct label for input data in the form of a carrier. Carrier data may be vectorized.

At step 275, the method 270 determines if a combination exists of a UE group and a carrier group for a similar time period. As described above, a unique combination between UE groups and area groups and time groups can represent a specific pattern. The AI/ML model corresponding to the combination can be applied to other new areas, UEs and time periods, for example. In the application phase, step 275 identifies one or more groups that have a suitable similarity and a similar time period. Any suitable similarity measurement or evaluation routine may be used.

If so, at step 276, the UE group and the carrier group are applied to the corresponding AI/ML model. Further, at step 277, the existing model is evaluated for the new UEs and areas. That is, the model developed during the build phase of FIG. 2D, step 267, is provided with data for the new, similar group of UEs and the new group of similar carriers to gauge the usefulness of the previously developed model for controlling the network of the target area. In the example of FIG. 2E, the accuracy of the model is compared with a threshold value to determine the reliability. Any suitable accuracy metric may be used and any suitable threshold value may be used to compare. If accuracy does not meet the threshold (that is, if the expected result is beyond the model prediction), control proceeds to step 279 to execute the building phase for the new areas. That is, the method 260 of FIG. 2D may be executed in full or in part to build new modes for the new UEs and new areas of the target area. For example, since UE data and carrier data have been collected at step 271 and step 272, the data collected there may be used to form the groups of carriers and UEs.

Otherwise, at step 279, the method 270 includes applying the existing model to the new target area. In some instances, the model may have to be modified or updated to accommodate differences between the prior area or UEs and the new target area. The new model may be used to control or optimize the network in the new target area.

In a particular application, the network identifies a UE experiences quality of service (QOS) violations. QoS relates to the relative priority given to a UE based on an application operating on the UE or other factors. For example, a UE engaged in a voice call receives relatively high priority. A UE used by a first responder also receives relatively high priority. In some situations, the UE may not be given the appropriate QoS level in the network while attached to and communication with a first cell site or gNodeB. The QoS violation may be due to a lack of additional capacity at a particular overloaded cell site. The cell site would like to give the necessary QoS priority to the UE but is unable to due to lack of available capacity. Any element of the network such as a base station or a device in the core network of the radio communications network may identify the QoS violation.

In response to identifying the QoS violation, the UE is classified to a particular UE group. The particular UE group may include UE devices having a particular aspect or characteristic or function in common. Further, the first cell site is classified to a particular carrier group. Similarly, the carriers of carrier group have a particular characteristic in common. Based on the particular UE group and the particular carrier group, a ML model is selected. Performance characteristics and traffic patterns for the particular UE group and the particular carrier group are then provided to the selected ML model.

In response, in this example, the ML model may identify a resolution to the QoS violation for the UE. The ML model may provide identification information for one or more UEs and information about corrective actions. The corrective actions are intended to remedy the QoS violations, in this example. For example, the ML model may provide a recommendation to hand over the UE from the current service cell site to a second target cell site, and provide identification information for the UE and the second target cell site. Such a handover will operate to provide load balancing among the cell sites of the RAN. The overloaded first cell site that is the serving cell offloads some of its traffic to one or more adjacent cell sites, freeing up capacity to provide the UE with the specified QoS. In an example, the UE is handed over to another cell site or other UEs are handed over. In another example, resource allocations to one or more UEs are adjusted to free up capacity and enable the UE to be given the appropriate QoS level.

While for purposes of simplicity of explanation, the respective processes are shown and described as a series of blocks in FIG. 2D and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

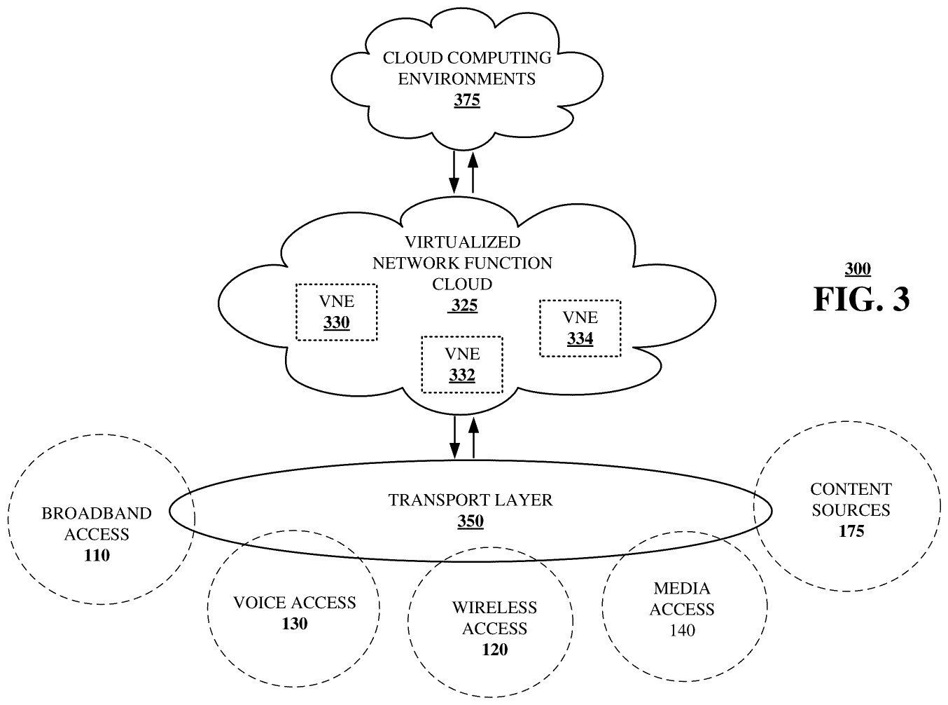

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 210, system 230, and method 260 and method 270 presented in FIG. 1, FIG. 2A, FIG. 2B, FIG. 2C, FIG. 2D, FIG. 2E and 3. For example, virtualized communication network 300 can facilitate in whole or in part grouping user equipment (UE) devices in a radio network according to performance characteristics and traffic patterns, grouping carriers in the radio network according to performance characteristics and traffic patterns, and combining the groups of UEs and groups of carriers according to common time information and thus forming AI/ML models based on the combinations.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

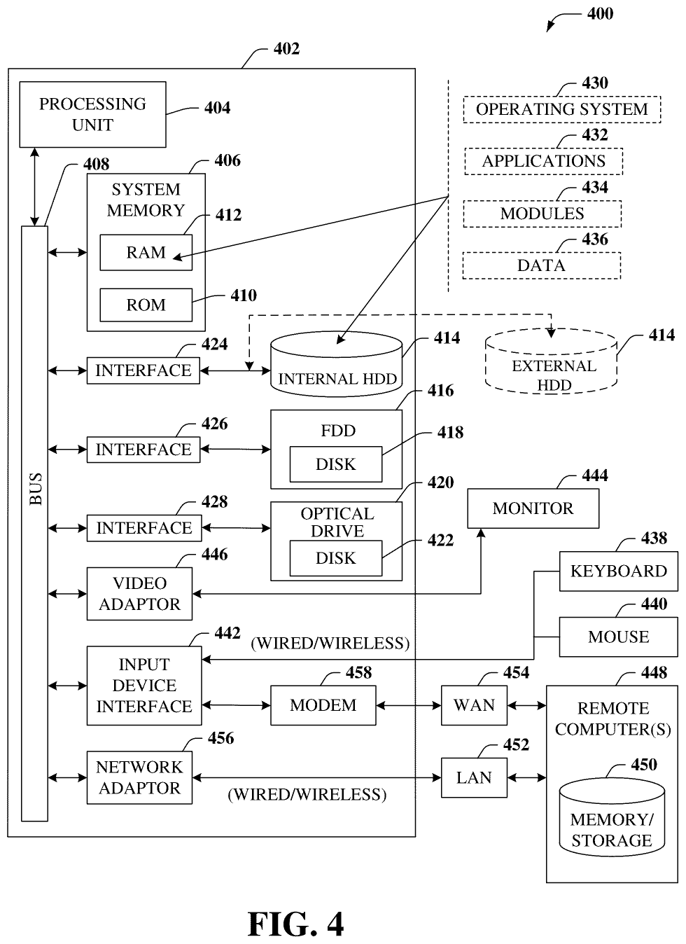

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part grouping user equipment (UE) devices in a radio network according to performance characteristics and traffic patterns, grouping carriers in the radio network according to performance characteristics and traffic patterns, and combining the groups of UEs and groups of carriers according to common time information and thus forming AI/ML models based on the combinations.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory”herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

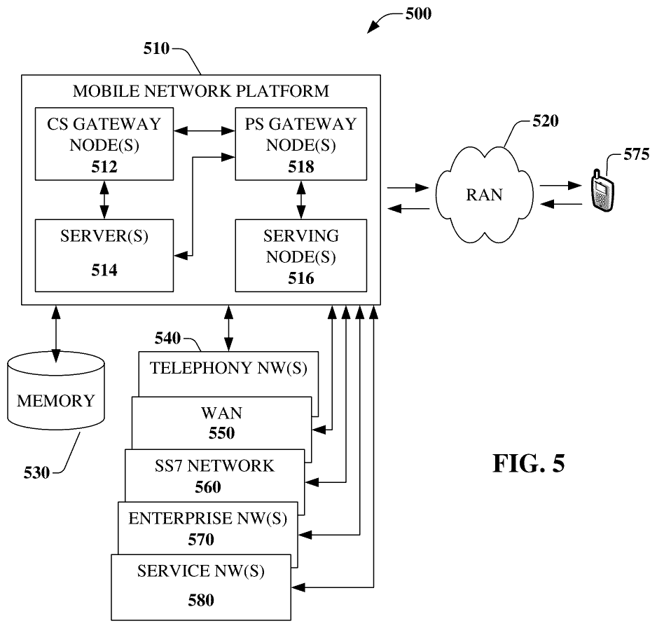

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part grouping user equipment (UE) devices in a radio network according to performance characteristics and traffic patterns, grouping carriers in the radio network according to performance characteristics and traffic patterns, and combining the groups of UEs and groups of carriers according to common time information and thus forming AI/ML models based on the combinations. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

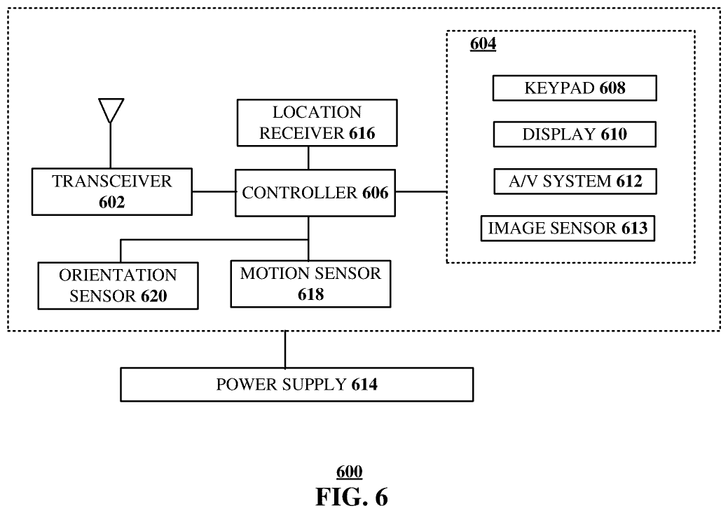

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part grouping user equipment (UE) devices in a radio network according to performance characteristics and traffic patterns, grouping carriers in the radio network according to performance characteristics and traffic patterns, and combining the groups of UEs and groups of carriers according to common time information and thus forming artificial intelligence/machine learning (AI/ML) models based on the combinations.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting user equipment (UE) performance data for UEs of a radio access network (RAN);
identifying common UE characteristics among the UE performance data;
forming UE groups based on the common UE characteristics, wherein UEs of a UE group share one or more common performance characteristics;
collecting carrier performance data for a carrier of the RAN;
identifying common carrier characteristics among the carrier performance data;
forming carrier groups based on the common carrier characteristics, wherein members of a carrier group share one or more common carrier performance characteristics;
combining a selected UE group and a selected carrier group based on a shared common time period associated with the common UE characteristics of the selected UE group and the common carrier characteristics of the selected carrier group, forming a combination;
training the combination for a target goal, forming a trained combination;
building a machine learning model based on the trained combination;
providing current usage data to the machine learning model;
receiving a network modification recommendation from the machine learning model, the network modification recommendation to improve a key performance indicator (KPI) of the RAN; and
modifying the RAN according to the network modification recommendation.

2. The device of claim 1, wherein the receiving a network modification recommendation comprises:
receiving a recommendation to hand over one or more UEs from a first cell site to a second cell site for load balancing among cell sites in the RAN.

3. The device of claim 2, wherein the operations further comprise:
identifying a UE experiencing a quality of service (QOS) violation in the RAN;
classifying the UE to a particular UE group;
classifying the first cell site to a particular carrier group;
selecting a particular machine learning (ML) model based on the particular UE group and the particular carrier group;
providing particular performance characteristics and traffic patterns of the particular UE group and the particular carrier group to the particular ML model;
receiving, from the ML model, identification information for the one or more UEs and corrective actions; and
applying the correcting actions from the ML model to initiate a RAN action to remedy the QoS violation.

4. The device of claim 1, wherein the operations further comprise:
identifying a target area for potential reuse of the machine learning model;
collecting new UE performance data for new UEs in the target area;
classifying the new UEs based on the new UE performance data to the UE groups based on similarity of performance characteristics of the new UE performance data and the common UE characteristics; and
based on the similarity of performance characteristics, building a new model for the target area, wherein the new model is based on the machine learning model to reduce effort required to build the new model.

5. The device of claim 4, wherein the operations further comprise:
providing current new area usage data to the new model;
receiving from the new model a new area modification recommendation; and
implementing the new area modification recommendation to improve key performance characteristics of the target area.

6. The device of claim 1, wherein the collecting UE performance data for UEs comprises:
identifying a plurality of key performance indicators (KPIs) for a plurality of UEs;
collecting information about current values for the plurality of KPIs for the plurality of UEs; and
grouping two or more UEs in a UE group based on the current values for the plurality of KPIs.

7. The device of claim 6, wherein the collecting carrier performance data for the carrier of the RAN further comprises:
collecting information about traffic patterns among cell sites of the RAN; and
grouping two or more cell sites in a carrier group based on the traffic patterns.

8. The device of claim 1, wherein the device comprises an Open RAN (O-RAN) non-real time RAN Intelligent Controller (non-RT RIC) operating in conjunction with an rApp or an O-RAN near-real time RIC (near-RT RIC) operating in conjunction with an xApp.

9. The device of claim 1, wherein the operations further comprise:
storing the machine learning model at a network location;
receiving, from a cell site, a request for the machine learning model; and
deploying the machine learning model from the network location to the cell site in response to the request for the machine learning model.

10. The device of claim 9, wherein the operations further comprise:
receiving, from the cell site, information about performance characteristics and traffic patterns of the cell site; and
receiving from the cell site the request for the machine learning model, the request specifying a machine learning model tailored for the information about performance characteristics and traffic patterns of the cell site.

11. A machine-readable medium, comprising executable instructions that, when executed by a processing system including a processor, facilitate performance of operations, the operations comprising:
classifying a user equipment (UE) in a radio access network (RAN) into a UE group according to performance data and UE time information, forming UE groups;
classifying each connected carrier of carriers of the RAN into a carrier group according to traffic patterns and carrier time information;
combining a selected UE group and selected carrier group based on common time information, forming a combination;
applying a machine learning (ML) model of the combination;
providing current UE performance information and current carrier traffic information to the ML model; and
receiving, from the ML model, a network modification recommendation to improve one or more key performance indicators (KPIs) of the RAN.

12. The machine-readable medium of claim 11, wherein the operations further comprise:
identifying a target area for modeling network behavior;
classifying UEs of the target area or carriers of the target area, or both, for particular time periods to a new ML model; and
reusing the new ML model based on similarity of performance data and traffic patterns, wherein reusing the new ML model comprises modifying the new ML model for use in the target area to provide requested network modifications for the target area.

13. The machine-readable medium of claim 11, wherein the receiving the network modification recommendation comprises:
receiving, from the ML model, a load balancing recommendation for a cell site of the RAN; and
handing over at least some UEs from the cell site of the RAN to a second cell site of the RAN to improve throughput for the at least some UEs.

14. The machine-readable medium of claim 11, wherein the operations further comprise:
receiving, at a core network associated with the RAN, a request from a cell site for a machine learning model; and
deploying the machine learning model to the cell site.

15. The machine-readable medium of claim 14, wherein the operations further comprise:
receiving, at the core network, from the cell site, information about performance characteristics of UEs attached to the cell site and traffic patterns at the cell site; and
deploying to the cell site the machine learning model modified according to the performance characteristics of UEs attached to the cell site and traffic patterns at the cell site for use by the cell site to improve one or more KPI of the cell site.

16. A method, comprising:
grouping, by a processing system including a processor, user equipment (UEs) of a radio access network (RAN) based on performance characteristics and traffic patterns of the UEs in the RAN, forming UE groups;
grouping, by the processing system, carriers of the RAN based on performance characteristics and traffic patterns of target areas of the RAN, forming carrier groups;
grouping, by the processing system; respective UE groups of the UE groups and respective carrier groups of the carrier groups according to respective time information common to a respective UE group and a respective carrier group, forming respective combinations; and
building respective machine learning models based on the respective combinations, each respective machine learning model operative to control a portion of the RAN based on input information about current activity in the RAN.

17. The method of claim 16, comprising:
providing, by the processing system, current UE performance information and current carrier traffic information to the ML model; and
receiving, by the processing system, from the ML model, a network modification recommendation to improve one or more key performance indicators (KPIs) of the RAN.

18. The method of claim 16, comprising:
receiving, by the processing system, information about throughput, latency and signal quality for UEs operating on the RAN;
grouping, by the processing system, the UEs according to similarities among the throughput, latency and signal quality;
receiving, by the processing system, information about traffic load, signal strength and handover success rate for UEs operating on the RAN; and
grouping, by the processing system, the carriers according to similarities among the traffic load, signal strength and handover success rate.

19. The method of claim 16, comprising:
adapting, by the processing system, a respective machine learning model for usage in a new area of the RAN, wherein the adapting is based on similarities of groups of UEs operating on the new area of the RAN and a selected UE group of the UE groups, and wherein the adapting is based on similarities of groups of carriers of the new area of the RAN and a respective carrier of the carrier groups.

20. The method of claim 16, comprising:
receiving, by the processing system, a request from a cell site for a machine learning model, the request including information about performance characteristics of UEs attached to the cell site and traffic patterns at the cell site; and
deploying, by the processing system, the machine learning model modified according to the performance characteristics of UEs attached to the cell site and traffic patterns at the cell site for use by the cell site to improve one or more KPI of the cell site.
